(19) United States
(12) Patent Application Publication
(10) Pub. No.: US 2022/0048529 A1
(43) Pub. Date: Feb. 17, 2022

(54) SYSTEM AND METHOD FOR PROVIDING IN-VEHICLE EMERGENCY VEHICLE DETECTION AND POSITIONAL ALERTS

(71) Applicant: Volvo Car Corporation, Göteborg (SE)

(72) Inventor: Sihao DING, Sunnyvale, CA (US)

(21) Appl. No.: 17/401,445

(22) Filed: Aug. 13, 2021

Related U.S. Application Data
(60) Provisional application No. 63/065,531, filed on Aug. 14, 2020.

(51) Int. Cl. B60W 50/16; G06K 9/00; G06K 9/62

(52) U.S. Cl. CPC B60W 50/16; G06K 9/00805; B60W 2554/4049; B60W 2420/42; G06K 9/6288

(57) ABSTRACT

A system for providing in-vehicle emergency vehicle detection and positional alerts, including: a camera configured to obtain an image of surroundings of an ego vehicle; an emergency vehicle recognition and localization module operable for segmenting an emergency vehicle from the image of the surroundings in order to detect and locate the emergency vehicle relative to the ego vehicle; a microphone configured to obtain an auditory signal from the surroundings of the ego vehicle; a siren detection and directional positioning module operable for discriminating an emergency vehicle siren from the auditory signal from the surroundings in order to detect and locate the emergency vehicle relative to the ego vehicle; and one or more of a visual alert, an audible alert, and a haptic alert operable for alerting a driver of the ego vehicle to a presence and the location of the emergency vehicle.

### TECHNICAL FIELD

The present disclosure relates generally to the automotive field. More particularly, the present disclosure relates to a system and method for providing in-vehicle emergency vehicle detection and positional alerts.

### BACKGROUND

An emergency vehicle is defined generally as a police car, a fire truck, an ambulance, or the like. When responding to an emergency, these emergency vehicles are likely moving (potentially at a high rate of speed) with flashing lights and broadcasting a siren. By law, when a driver is approached or passed by an emergency vehicle, the driver must move over, slow down, stop, and/or otherwise give way and provide the emergency vehicle with safe passage. However, sometimes the driver fails to promptly notice the emergency vehicle, or fails to properly judge the emergency vehicle's position and direction of travel. This can result due to driver inattention, poor visibility, ambient noise, etc. The outcome may be unintended interference with the emergency vehicle, slowing its response to an emergency, or, in a worst case scenario, a traffic incident involving the ego vehicle and the emergency vehicle.

The present background is provided as illustrative environmental context only. It will be readily apparent to those of ordinary skill in the art that the principles and concepts of the present disclosure may be implemented in other environmental contexts equally, without limitation.

### SUMMARY

The present disclosure provides an in-vehicle system that alerts a driver to the presence and position of a detected emergency vehicle. The emergency vehicle is detected by the ego vehicle using both video and audio methodologies.

In one illustrative embodiment, the present disclosure provides a system for providing in-vehicle emergency vehicle detection and positional alerts, the system including: a camera coupled to an ego vehicle and configured to obtain an image of surroundings of the ego vehicle; an emergency vehicle recognition and localization module coupled to the camera and operable for segmenting an emergency vehicle from the image of the surroundings in order to detect and locate the emergency vehicle relative to the ego vehicle; a microphone coupled to the ego vehicle and configured to obtain an auditory signal from the surroundings of the ego vehicle; a siren detection and directional positioning module coupled to the microphone and operable for discriminating an emergency vehicle siren from the auditory signal from the surroundings in order to detect and locate the emergency vehicle relative to the ego vehicle; and one or more of a visual alert, an audible alert, and a haptic alert operable for alerting a driver of the ego vehicle to a presence and the location of the emergency vehicle relative to the ego vehicle responsive to output from the emergency vehicle recognition and localization module and the siren detection and directional positioning module.

In another illustrative embodiment, the present disclosure provides a method for providing in-vehicle emergency vehicle detection and positional alerts, the method including: obtaining an image of surroundings of an ego vehicle using a camera coupled to the ego vehicle; segmenting an emergency vehicle from the image of the surroundings using an emergency vehicle recognition and localization module coupled to the camera in order to detect and locate the emergency vehicle relative to the ego vehicle; obtaining an auditory signal from the surroundings of the ego vehicle using a microphone coupled to the ego vehicle; discriminating an emergency vehicle siren from the auditory signal from the surroundings using a siren detection and directional positioning module coupled to the microphone in order to detect and locate the emergency vehicle relative to the ego vehicle; and alerting a driver of the ego vehicle to a presence and the location of the emergency vehicle relative to the ego vehicle using one or more of a visual alert, an audible alert, and a haptic alert responsive to output from the emergency vehicle recognition and localization module and the siren detection and directional positioning module.

In a further illustrative embodiment, the present disclosure provides a non-transitory computer-readable medium stored in a memory and executed by a processor to carry out steps for providing in-vehicle emergency vehicle detection and positional alerts, the steps including: obtaining an image of surroundings of an ego vehicle using a camera coupled to the ego vehicle; segmenting an emergency vehicle from the image of the surroundings using an emergency vehicle recognition and localization module coupled to the camera in order to detect and locate the emergency vehicle relative to the ego vehicle; obtaining an auditory signal from the surroundings of the ego vehicle using a microphone coupled to the ego vehicle; discriminating an emergency vehicle siren from the auditory signal from the surroundings using a siren detection and directional positioning module coupled to the microphone in order to detect and locate the emergency vehicle relative to the ego vehicle; and alerting a driver of the ego vehicle to a presence and the location of the emergency vehicle relative to the ego vehicle using one or more of a visual alert, an audible alert, and a haptic alert responsive to output from the emergency vehicle recognition and localization module and the siren detection and directional positioning module.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram of one illustrative embodiment of the emergency vehicle alert system of the present disclosure;

FIG. 2 is a representation of a display of the emergency vehicle alert system of the present disclosure;

FIG. 3 is a network diagram of a cloud-based environment for implementing various cloud-based services of the present disclosure;

FIG. 4 is a block diagram of a server that may be used stand-alone, in a networked environment, or in the cloud-based system of FIG. 3;

FIG. 5 is a block diagram of a user device that may be used in a connected environment or the cloud-based system of FIG. 3; and

FIG. 6 is a schematic diagram of one illustrative embodiment of the emergency vehicle alert method of the present disclosure.

### DETAILED DESCRIPTION

Again, the present disclosure provides an in-vehicle system that alerts a driver to the presence and position of a detected emergency vehicle. The emergency vehicle is detected by the ego vehicle using both video and audio methodologies.

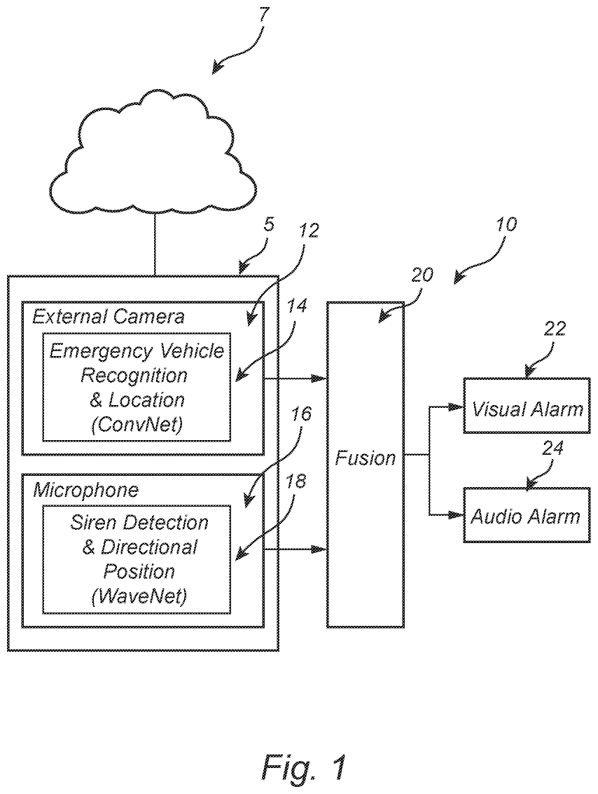

Referring now specifically to FIG. 1, in one illustrative embodiment, the emergency vehicle alert system 10 of the ego vehicle 5 of the present disclosure includes one or more external cameras 12 that are configured to obtain an image or images of the surroundings of the ego vehicle 5. The one or more external cameras 12 may include a front-facing camera, a rear-facing camera, a side-facing camera, a bird's-eye-view (BEV) camera, a 360 camera, and/or the like. The image or images are those typically used to orient the ego vehicle 5 in space and for object detection and the like. Accordingly, one or more external cameras 12 can be replaced with one or more similar perception sensors used for the same or similar purposes, such as one or more radar sensors, lidar sensors, etc.

The image or images are provided to an emergency vehicle recognition and localization module 14 resident in a memory store of the ego vehicle 5 or in the cloud 7. The emergency vehicle recognition and localization module 14 implements a Convolutional Neural Network (ConvNet) and a combination of classical computer vision techniques, well known to those or ordinary skill in the art, to detect, localize, and track an emergency vehicle object in the image or images. Object detection may be used to identify objects within the images/video, typically outputting labels for multiple different items within the field of view of the camera system. For example, it is important for in-vehicle detection to be able to identify different types of vehicles, including cars, trucks, motorcycles, etc. Object tracking may be used to follow the particular object of interest, in this case one or more emergency vehicles, after initial object detection to give the driver of the ego vehicle 5 real time updates on the location of the emergency vehicle. In the case of a self-driving or driver-assisted ego vehicle 5, the system may also receive the location of the emergency vehicle and react accordingly. The emergency vehicle alert system 10 of the present disclosure may use these aforementioned computer vision techniques or a plurality of other methods known to one of ordinary skill in the art.

In order for a computer vision system to be operable, the system must be able to distinguish the object of interest. Emergency vehicles have prominent visual features, especially when the flashing lights are on. Thus, such emergency vehicles may be easily identified, located, and tracked relative to the ego vehicle 5. Multiple cameras 12 also allow for greater field of view and perception accuracy, as images may be combined, compared, and otherwise used synergistically.

The emergency vehicle alert system 10 of the ego vehicle 5 of the present disclosure also includes one or more microphones 16 that are configured to obtain an audio signal or signals from the surroundings of the ego vehicle 5. The one or more microphones 16 may include a front-facing microphone, a rear-facing microphone, a side-facing microphone, a directional microphone, a 360-degree microphone, and/or the like. The audio signal or signals are those typically used to detect the presence and position of a person or object outside the ego vehicle 5. The audio signal or signals are provided to a siren detection and directional positioning module 18 resident in the memory store of the ego vehicle 5 or in the cloud 7. The siren detection and directional positioning module 18 implements a Wavelength Neural Network (WaveNet) and classical computer hearing techniques, well known to those or ordinary skill in the art, to detect, localize, and track the emergency vehicle using the audio signal or signals. Emergency vehicles make distinct sounds, especially when the sirens are on. Thus, such emergency vehicles may be easily identified, located, and tracked relative to the ego vehicle 5. Multiple microphones 16 also allow for greater field of hearing and perception accuracy, as well as the use of triangulation techniques.

The visual recognition and audio recognition above are fused 20 to confirm the presence, location, and direction of travel of the emergency vehicle and an appropriate visual alert or alarm 22 and/or auditory alert or alarm 24 is/are issued to the driver in the ego vehicle 5. The visual alert or alarm 22 may consist of an appropriate display and/or warning light, and the auditory alert or alarm 24 may consist of an appropriate audible sound. A haptic alert or alarm may also be used in conjunction with the visual alert or alarm 22 and/or auditory alert or alarm 24. It should be noted that any alert or alarm utilized may be progressive, escalating from a gently “nudge” to an urgent “insistence” to an ego vehicle-initiated driver-assistance or self-driving operational intervention executed via the ego vehicle's advanced driver assistance system (ADAS) or autonomous driving (AD) and braking/steering systems. The fusion module and process 20 are operable for determining a degree of agreement between the visual recognition and the audio recognition, with significant thresholded disagreements being flagged. Further, the fusion module and process 20 can supplement one of the visual recognition and the audio recognition with the other, thereby enhancing the collective certainty and accuracy of the two.

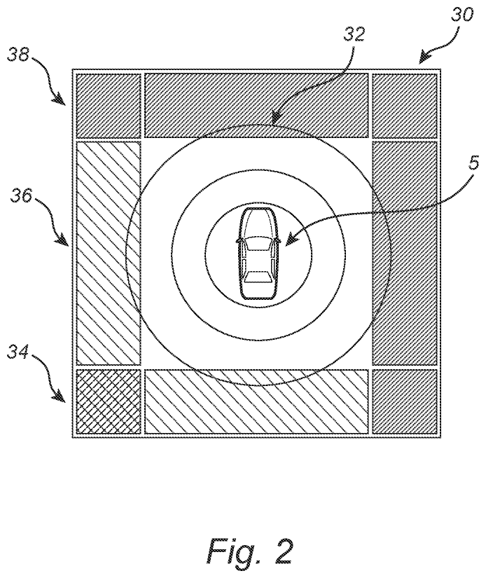

FIG. 2 illustrates a potential driver display 30 associated with the visual alert 22 of the present disclosure, which may be accompanied by the aforementioned audio alert 24 and/or haptic alert. This driver display 30 may include the location of the ego vehicle 5 in a perspective, point-of-view (POV), or BEV context, as well as gradient lines 32 that indicate relative distance from the ego vehicle 5. Using “heat map” coded regions or the like, the relative location 34 of the detected emergency vehicle is indicated, as well as adjacent regions 36 close to the detected emergency vehicle and distant regions 38 remote from the detected emergency vehicle. Thus, a driver touch-screen warning can be utilized, and/or a heads-up display (HUD) warning, and/or a blind-spot indicator system (BLIS)-like warning. All of these warnings provide directional information related to an approaching emergency vehicle, even if the driver is inattentive/unaware. Directional audio alerts or voice alerts may similarly be provided, as well as haptic alerts.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

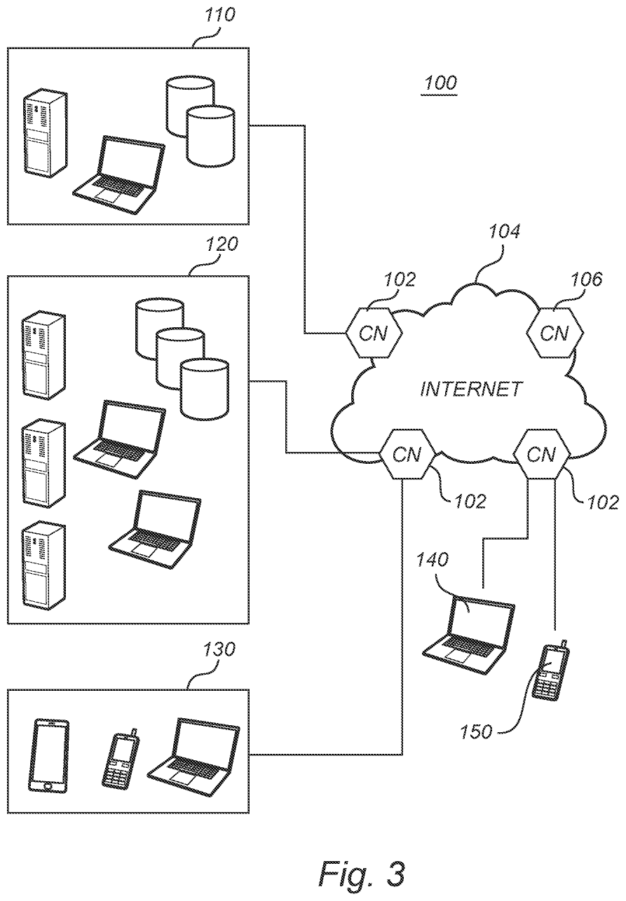

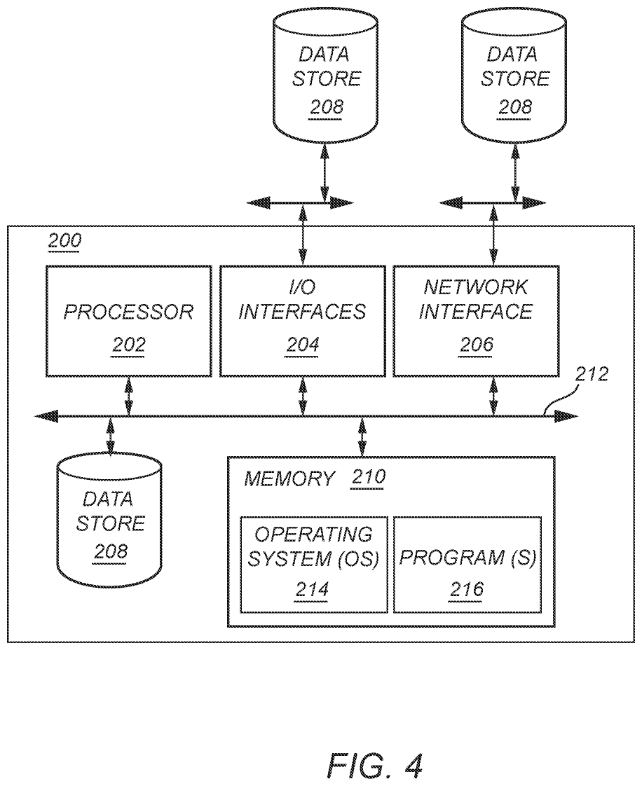

FIG. 3 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 4) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

The cloud-based system 100 can provide any functionality through services such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application necessarily required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 4 is a block diagram of a server 200, which may be used in the cloud-based system 100 (FIG. 3), in other networked systems, or stand-alone. For example, the CNs 102 (FIG. 3) and the central authority nodes 106 (FIG. 3) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 3). The network interface 206 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

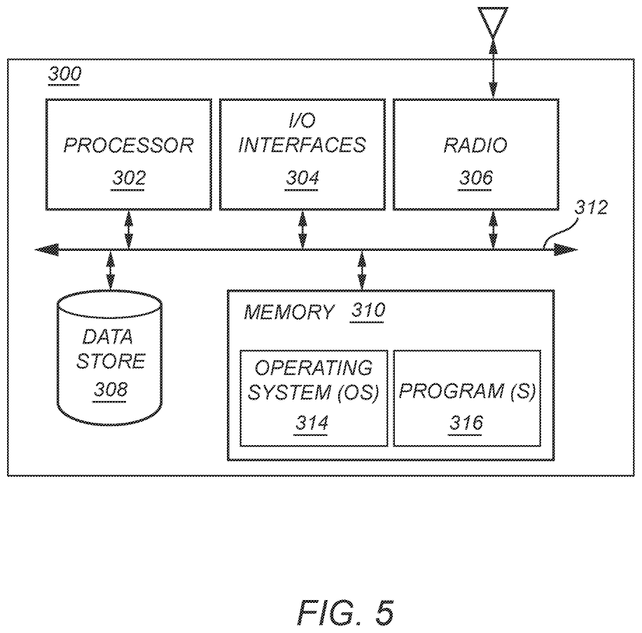

FIG. 5 is a block diagram of a user device 300, which may be used in the cloud-based system 100 (FIG. 3) or the like. Again, the user device 300 can be a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100 (FIG. 3).

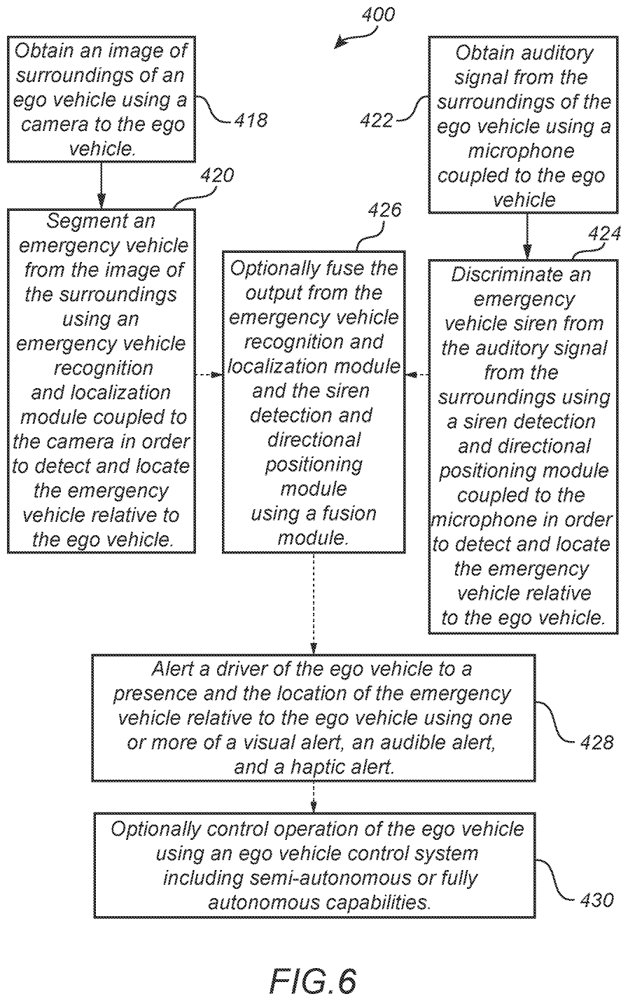

Referring now specifically to FIG. 6, the method 400 of the present disclosure is described. An image of the surroundings of the ego vehicle is obtained using one or more external cameras that are configured to obtain an image or images of the surroundings of the ego vehicle. The one or more external cameras 12 may include a front-facing camera, a rear-facing camera, a side-facing camera, a bird's-eye-view (BEV) camera, a 360 camera, and/or the like. An emergency vehicle is then segmented from the image of the surroundings using the emergency vehicle recognition and localization module in order to detect and locate the emergency vehicle relative to the ego vehicle. In conjunction with the above-mentioned steps, or alone, an auditory signal of the surroundings of the ego vehicle is obtained using microphones that may include a front-facing microphone, a rear-facing microphone, a side-facing microphone, a directional microphone, a 360-degree microphone, and/or the like. The auditory signal is then processed to discriminate an emergency vehicle siren from the surroundings using the siren detection and directional positioning module in order to detect and locate the emergency vehicle relative to the ego vehicle. It will be known to one of ordinary skill in the art that both of these previously mentioned (image and auditory) detection methods may be used together or individually. When both image and auditory detection is provided, the outputs of the emergency vehicle recognition and localization module and the siren detection and directional positioning module are fused to further increase the accuracy of the method using the fusion module. The driver of the ego vehicle is then alerted to the presence and location of the emergency vehicle relative to the ego vehicle with one or more of a visual alert, audible alert, and a haptic alert. In the case of a semi-autonomous or fully autonomous ego vehicle, the vehicle control system may take control of the ego vehicle and perform one or more maneuvers. Automated control of the ego vehicle may also take over if the driver of the ego vehicle fails to adequately respond to the one or more of the visual alert, the audible alert, and the haptic alert related to the presence and the location of the emergency vehicle relative to the ego vehicle.

Although the present disclosure is illustrated and described herein with reference to illustrative embodiments and specific examples thereof, it will be readily apparent to those of ordinary skill in the art that other illustrative embodiments and examples may perform similar functions and/or achieve like results. All such equivalent illustrative embodiments and examples are within the spirit and scope of the present disclosure, are contemplated thereby, and are intended to be covered by the following non-limiting claims for all purposes.

What is claimed is:

1. A system for providing in-vehicle emergency vehicle detection and positional alerts, the system comprising:
a camera coupled to an ego vehicle and configured to obtain an image of surroundings of the ego vehicle;
memory storing instructions executed by a processor to provide an emergency vehicle recognition and localization module coupled to the camera and operable for segmenting an emergency vehicle from the image of the surroundings in order to detect and locate the emergency vehicle relative to the ego vehicle;
a microphone coupled to the ego vehicle and configured to obtain an auditory signal from the surroundings of the ego vehicle;
memory storing instructions executed by a processor to provide a siren detection and directional positioning module coupled to the microphone and operable for discriminating an emergency vehicle siren from the auditory signal from the surroundings in order to detect and locate the emergency vehicle relative to the ego vehicle; and
one or more of a visual alert device, an audible alert device, and a haptic alert device operable for alerting a driver of the ego vehicle to a presence and the location of the emergency vehicle relative to the ego vehicle responsive to output from the emergency vehicle recognition and localization module and the siren detection and directional positioning module.

2. The system of claim 1, further comprising memory storing instructions executed by a processor to provide a fusion module operable for fusing the output from the emergency vehicle recognition and localization module and the siren detection and directional positioning module.

3. The system of claim 2, wherein the fusion module is operable for fusing the output from the emergency vehicle recognition and localization module and the siren detection and directional positioning module by comparing the output from the emergency vehicle recognition and localization module and the siren detection and directional positioning module with one another.

4. The system of claim 2, wherein the fusion module is operable for fusing the output from the emergency vehicle recognition and localization module and the siren detection and directional positioning module by supplementing the output from the emergency vehicle recognition and localization module and the siren detection and directional positioning module with one another.

5. The system of claim 1, further comprising a display operable for displaying the location of the emergency vehicle relative to the ego vehicle to the driver of the ego vehicle responsive to the output from the emergency vehicle recognition and localization module and the siren detection and directional positioning module.

6. The system of claim 1, further comprising an ego vehicle control system operable for controlling operation of the ego vehicle responsive to the output from the emergency vehicle recognition and localization module and the siren detection and directional positioning module.

7. The system of claim 6, wherein controlling operation of the ego vehicle responsive to the output from the emergency vehicle recognition and localization module and the siren detection and directional positioning module occurs subsequent to a determination by the ego vehicle that the driver has failed to adequately respond to the one or more of the visual alert, the audible alert, and the haptic alert related to the presence and the location of the emergency vehicle relative to the ego vehicle.

8. A method for providing in-vehicle emergency vehicle detection and positional alerts, the method comprising:
obtaining an image of surroundings of an ego vehicle using a camera coupled to the ego vehicle;
segmenting an emergency vehicle from the image of the surroundings using an emergency vehicle recognition and localization module coupled to the camera in order to detect and locate the emergency vehicle relative to the ego vehicle;
obtaining an auditory signal from the surroundings of the ego vehicle using a microphone coupled to the ego vehicle;
discriminating an emergency vehicle siren from the auditory signal from the surroundings using a siren detection and directional positioning module coupled to the microphone in order to detect and locate the emergency vehicle relative to the ego vehicle; and
alerting a driver of the ego vehicle to a presence and the location of the emergency vehicle relative to the ego vehicle using one or more of a visual alert, an audible alert, and a haptic alert responsive to output from the emergency vehicle recognition and localization module and the siren detection and directional positioning module.

9. The method of claim 8, further comprising fusing the output from the emergency vehicle recognition and localization module and the siren detection and directional positioning module using a fusion module.

10. The method of claim 9, wherein fusing the output from the emergency vehicle recognition and localization module and the siren detection and directional positioning module comprises comparing the output from the emergency vehicle recognition and localization module and the siren detection and directional positioning module with one another.

11. The method of claim 9, wherein fusing the output from the emergency vehicle recognition and localization module and the siren detection and directional positioning module comprises supplementing the output from the emergency vehicle recognition and localization module and the siren detection and directional positioning module with one another.

12. The method of claim 8, further comprising displaying the location of the emergency vehicle relative to the ego vehicle to the driver of the ego vehicle on a display responsive to the output from the emergency vehicle recognition and localization module and the siren detection and directional positioning module.

13. The method of claim 8, further comprising controlling operation of the ego vehicle using an ego vehicle control system responsive to the output from the emergency vehicle recognition and localization module and the siren detection and directional positioning module.

14. The method of claim 13, wherein controlling operation of the ego vehicle responsive to the output from the emergency vehicle recognition and localization module and the siren detection and directional positioning module occurs subsequent to a determination by the ego vehicle that the driver has failed to adequately respond to the one or more of the visual alert, the audible alert, and the haptic alert related to the presence and the location of the emergency vehicle relative to the ego vehicle.

15. A non-transitory computer-readable medium stored in a memory and executed by a processor to carry out steps for providing in-vehicle emergency vehicle detection and positional alerts, the steps comprising:
obtaining an image of surroundings of an ego vehicle using a camera coupled to the ego vehicle;
segmenting an emergency vehicle from the image of the surroundings using an emergency vehicle recognition and localization module coupled to the camera in order to detect and locate the emergency vehicle relative to the ego vehicle;
obtaining an auditory signal from the surroundings of the ego vehicle using a microphone coupled to the ego vehicle;
discriminating an emergency vehicle siren from the auditory signal from the surroundings using a siren detection and directional positioning module coupled to the microphone in order to detect and locate the emergency vehicle relative to the ego vehicle; and
alerting a driver of the ego vehicle to a presence and the location of the emergency vehicle relative to the ego vehicle using one or more of a visual alert, an audible alert, and a haptic alert responsive to output from the emergency vehicle recognition and localization module and the siren detection and directional positioning module.

16. The non-transitory computer-readable medium of claim 15, wherein the steps further comprise fusing the output from the emergency vehicle recognition and localization module and the siren detection and directional positioning module using a fusion module.

17. The non-transitory computer-readable medium of claim 15, wherein the steps further comprise displaying the location of the emergency vehicle relative to the ego vehicle to the driver of the ego vehicle on a display responsive to the output from the emergency vehicle recognition and localization module and the siren detection and directional positioning module.

18. The non-transitory computer-readable medium of claim 15, wherein the steps further comprise controlling operation of the ego vehicle using an ego vehicle control system responsive to the output from the emergency vehicle recognition and localization module and the siren detection and directional positioning module.

19. The non-transitory computer-readable medium of claim 14, wherein controlling operation of the ego vehicle responsive to the output from the emergency vehicle recognition and localization module and the siren detection and directional positioning module occurs subsequent to a determination by the ego vehicle that the driver has failed to adequately respond to the one or more of the visual alert, the audible alert, and the haptic alert related to the presence and the location of the emergency vehicle relative to the ego vehicle.

20. The non-transitory computer-readable medium of claim 15, wherein fusing the output from the emergency vehicle recognition and localization module and the siren detection and directional positioning module comprises one or more of: comparing the output from the emergency vehicle recognition and localization module and the siren detection and directional positioning module with one another and supplementing the output from the emergency vehicle recognition and localization module and the siren detection and directional positioning module with one another.
